(19) United States
(12) Patent Application Publication
(10) Pub. No.: US 2015/0281051 A1
(43) Pub. Date: Oct. 1, 2015

(54) METHOD AND APPARATUS FOR CREATING VIRTUAL TRAFFIC ENGINEERING LINK

(71) Applicant: Electronics and Telecommunications Research Institute, Daejeon (KR)

(72) Inventors: Kyeong Eun HAN, Daejeon (KR); Sun Me KIM, Daejeon (KR); Tae Hyun KWON, Daejeon (KR); Eun Young CHO, Daejeon (KR); Jong Hyun LEE, Daejeon (KR)

(21) Appl. No.: 14/664,132

(22) Filed: Mar. 20, 2015

(30) Foreign Application Priority Data
Mar. 31, 2014 (KR) 10-2014-0037495

(51) Int. Cl. H04L 12/723; H04L 12/741; H04B 10/27

(52) U.S. Cl. CPC H04L 45/50; H04B 10/27; H04L 45/74

(57) ABSTRACT

Provided is a method and apparatus for creating a virtual traffic engineering (TE) link in an upper layer of an optical transport network (OTN). To create a virtual TE link, a node may determine to create the virtual TE link in an upper layer of an OTN, and may set up a forwarding adjacency (FA)-label switched path (LSP) between nodes in an OTN layer. The FA-LSP may be set up on a control plane of the OTN layer. The node may create the virtual TE link by registering the setup FA-LSP as a TE link of the upper layer of the node.

### CROSS-REFERENCE TO RELATED APPLICATION

This application claims the priority benefit of Korean Patent Application No. 10-2014-0037495, filed on Mar. 31, 2014, in the Korean Intellectual Property Office, the disclosure of which is incorporated herein by reference.

### BACKGROUND

1. Field of the Invention

Embodiments of the following description relate to technology for setting a traffic engineering (TE) link of a node, and more particularly, to a method and apparatus for creating a virtual TE link of an upper layer of an optical transport network (OTN).

2. Description of the Related Art

A path set up on a network to transmit data may require network resources of an upper layer. When available network resources of the upper layer are insufficient, network resources of a lower layer may be used for a path to be set up. Using network resources of the lower layer for the path to be set up may indicate effectively using network resources.

However, in the case of using network resources of the lower layer for the path to be set up, a network topology of each layer may be change. The change in the network topology may decrease a rigidity of a network. Accordingly, using resources of the lower layer for the path to be set up may have a tradeoff relationship in terms of an effective use of network resources and a decrease in the network rigidity.

### SUMMARY

Embodiments provide a method and apparatus for creating a virtual traffic engineering (TE) link in a node of an upper layer of an optical transport network (OTN).

Embodiments also provide a method and apparatus for allocating a label indicating that a TE link of a node is a virtual TE link.

According to an aspect, there is provided a method of creating a virtual TE link, performed at a first node of an OTN, the method including: determining to create a virtual TE link that connects the first node and a second node in an upper layer of the OTN: setting up a forwarding adjacency (FA)-label switched path (LSP) between the first node and the second node on a control plane of an OTN layer to create the virtual TE link; and creating the virtual TE link by registering the setup FA-LSP as a TE link of the upper layer of the first node.

The FA-LSP may be set up on the control plane between the control plane and a data plane of the OTN layer.

The setting up of the FA-LSP may include setting up the FA-LSP using a traffic parameter.

The virtual TE creating method may further include: determining whether the TE link of the first node is the virtual TE link; and allocating a label indicating that the TE link is a normal TE link when the TE link is determined as the normal TE link.

The virtual TE creating method may further include: allocating, to the TE link, a label indicating that the TE link is the virtual TE link when the TE link is determined as the virtual TE link. Here, the label indicating that the TE link is the virtual TE link may be used to allocate resources of the first node of the OTN layer for the virtual TE link when the virtual TE link is set for an LSP for transferring a packet.

The label may be provided in a format of an OTN label. The label may include a tributary port number (TPN) field, a reserved (RES) field, a length field, and a bitmap field. Each of at least one bit of the bitmap field may have a value of “0”.

When a signal is multiplexed, a value of the TPN field may be determined based on a high order of the signal and a multiplexed low order of the signal. A value of the length field may be the number of tributary slots indicated by the high order, and the bitmap field may include at least one bit corresponding to the number of tributary slots.

The label may be provided in a format of an OTN label. The label may include a TPN field, a RES field, and a length field. Each of bits of the TPN field, the RES field, and the length field may have a value of “1”.

The label may be provided in a format of an OTN label. The label may include a TPN field, a RES field, and a length field. The RES field may include a T-flag. A value indicating that the TE link is the virtual TE link may be indicated in the T-flag.

The value indicting that the TE link is the virtual TE link may be “1”. Each of remaining bits excluding the T-flag from among bits of the RES field, bits of the TPN field, and bits of the length field may have a value of “0”.

The label may be provided in a format of an OTN label. The label may include a TPN field, a RES field, and a length field. Each of bits of the TPN field may have a value of “1”. Each of bits of the RES field and bits of the length field may have a value of “0”.

The label may be provided in a format of an OTN label. The label may include a TPN field, a RES field, a length field, and a bitmap field. When a signal is multiplexed, a value of the TPN field may be determined based on a high order of the signal and a multiplexed low order of the signal. The bitmap field may indicate, using a bitmap, whether a tributary slot of the first node for the virtual TE link is allocated, with respect to each tributary slot of the first node. The length field may indicate the number of valid bits of the bitmap field. The RES field may include a T-flag. A value of a bit indicating that the TE link is the virtual TE link may be indicated in the T-flag.

The virtual TE creating method may further include: receiving, from a third node, a reservation message requesting a reservation of the TE link of the first node, to set up an LSP for transferring a packet in the upper layer; and reserving an available TE link among at least one TE link of the first node.

The virtual TE creating method may further include: determining whether the TE link of the first node is the virtual TE link; allocating, to the TE link, a label indicating that the TE link is the virtual TE link when the TE link is determined as the virtual TE link; and performing signaling between the first node and the second node of the OTN layer based on the label, when the reserved TE link is the virtual TE link.

The label may be used to allocate resources of the first node of the OTN layer for the virtual TE link when the virtual TE link is set for the LSP, and the resources of the first node may be set through signaling.

The setting up of the FA-LSP may include setting up the FA-LSP using a traffic parameter, and the performing of the signaling may include performing the signaling using the traffic parameter.

The virtual TE creating method may further include: transmitting, to the second node, a reservation message requesting a reservation of a TE link of the second node to set up the LSP; receiving, from the second node, a setting message associated with setting the TE link of the second node; setting the reserved available TE link in the first node for the LSP; and transmitting, to the third node, the setting message associated with setting the TE link of the second node.

The virtual TE creating method may further include: determining whether the TE link of the first node is the virtual TE link; allocating, to the TE link, a label indicating that the TE link is the virtual TE link when the TE link is determined as the virtual TE link; receiving, from an operator of the OTN, an LSP for transferring a packet in the upper layer, wherein the first node is one of nodes of the LSP; and performing signaling between the first node and the second node of the OTN layer based on the label, when the TE link of the first node used for the LSP is the virtual TE link.

The label may be used to allocate resources of the first node of the OTN layer for the virtual TE link when the virtual TE link is set for the LSP, and the resources of the first node may be set through signaling.

According to another aspect, there is provided a first node of an OTN, the first node including: a processor configured to determine to create a virtual TE link that connects the first node and a second node in an upper layer of the OTN, to set up an FA-LSP between the first node and the second node on an OTN layer to create the virtual TE link, and to create the virtual TE link by registering the setup FA-LSP as a TE link of the upper layer of the first node. The FA-LSP may be set up on a control plane of the OTN layer.

According to still another aspect, there is provided a method of allocating a label, the method including: determining whether a TE link of a node of an OTN is a virtual TE link; and allocating a label indicating that the TE link is the virtual TE link when the TE link is determined as the virtual TE link. The virtual TE link may be created based on an FA-LSP of a lower layer of the node. The FA-LSP may be set up on a control plane of the lower layer. When the virtual TE link is set for an LSP for transferring a packet, the label may be used to allocate resources of the node of the lower layer for the virtual TE link.

The label may be provided in a format of an OTN label.

### Effect

According to embodiments, there may be provided a method and apparatus for creating a virtual traffic engineering (TE) link in a node of an upper layer of an optical transport network (OTN).

Also, according to embodiments, there may be provided a method and apparatus for allocating a label indicating that a TE link of a node is a virtual TE link.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a block diagram illustrating a configuration of a node according to an embodiment;

FIG. 2 is a flowchart illustrating a method of creating a virtual traffic engineering (TE) link according to an embodiment;

FIG. 3 illustrates an example of an upper layer of an optical transport network (OTN) according to an embodiment;

FIG. 4 illustrates an example of setting up a forwarding adjacency (FA)-label switched path (LSP) in an OTN layer according to an embodiment;

FIG. 5 illustrates an example of an upper layer in which a virtual TE link is created according to an embodiment;

FIG. 6 is a flowchart illustrating a method of allocating a label to a TE link according to an embodiment;

FIG. 7 illustrates an example of a format of an OTN label according to an embodiment;

FIG. 8 illustrates an example of a label indicating that a TE link is a virtual TE link using a tributary port number (TPN) field and a bitmap field according to an embodiment;

FIG. 9 illustrates an example of a label indicating that a TE link is a virtual TE link using a TPN field, a reserved (RES) field, and a length field according to an embodiment;

FIG. 10 illustrates an example of a label indicating that a TE link is a virtual TE link using a T-flag according to an embodiment;

FIG. 11 illustrates an example of a label indicating that a TE link is a virtual TE link using a TPN field according to an embodiment;

FIG. 12 illustrates an example of a label indicating that a TE link is a virtual TE link using a T-flag within a RES field according to an embodiment; and

FIG. 13 is a flowchart illustrating a signaling method between nodes to set up an LSP in an upper layer of an OTN according to an embodiment.

### DETAILED DESCRIPTION

Reference will now be made in detail to embodiments, examples of which are illustrated in the accompanying drawings, wherein like reference numerals refer to like elements throughout. Embodiments are described below to explain the present invention by referring to the figures.

Various alternations and modifications may be made to embodiments, some of which will be illustrated in the drawings and will be described in the detailed description. However, it should be understood that these embodiments are construed as limited to the embodiments set forth herein. Rather, the embodiments should be understood to include all the modifications and equivalents through replacements included in technical spirit and scope of the invention.

The terminology used herein is for describing particular embodiments only and is not intended to be limiting of embodiments. As used herein, the singular forms “a”, “an”, and “the” are intended to include the plural forms as well, unless the context clearly indicates otherwise. It will be further understood that the terms “comprises/includes” and/or “comprising/including”, when used in this specification, specify the presence of stated features, integers, steps, operations, elements, and/or components, or do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will be interpreted in an idealized or overly formal sense unless expressly so defined herein.

Also, when describing embodiments by referring to the accompanying drawings, like reference numerals refer to like constituent elements and a repeated description related thereto will be omitted. When it is determined detailed description related to a related known function or configuration they may make the purpose of the embodiments unnecessarily ambiguous in describing the present invention, the detailed description will be omitted here.

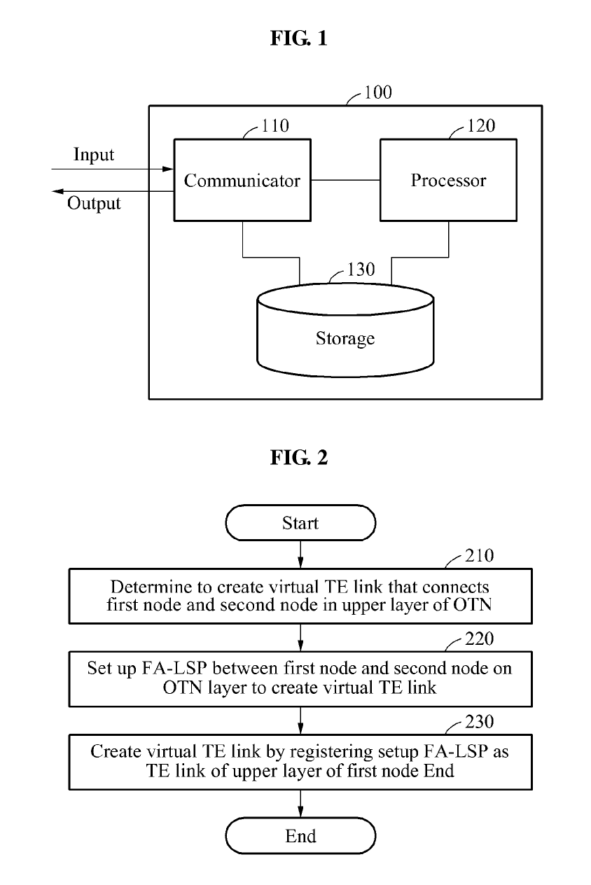

FIG. 1 is a block diagram illustrating a configuration of a node 100 according to an embodiment.

The node 100 may refer to a node of a multi-layer network (MLN) or a multi-regional network (MRN). For example, the MLN may be an optical transport network (OTN).

The node 100 may refer to at least one of a switch, a router, a hub, and a sharer.

The node 100 may have resources corresponding to at least one layer of multiple layers. For example, the node 100 may have resources of an upper layer and a lower layer of the OTN. The lower layer may be an OTN layer.

Resources may include a traffic engineering (TE) link between the node 100 and a node adjacent to the node 100 and a tributary slot (TS) of the node for the TE link.

At least one TE link of the node 100 may include at least one of a normal TE link and a virtual TE link. The normal TE link may refer to a TE link set using resources of the upper layer of the node 100. The virtual TE link may refer to a TE link set using resources of the lower layer of the node 100. For example, the virtual TE link may be created based on a forward adjacency (FA)-label switched path (LSP) of the lower layer.

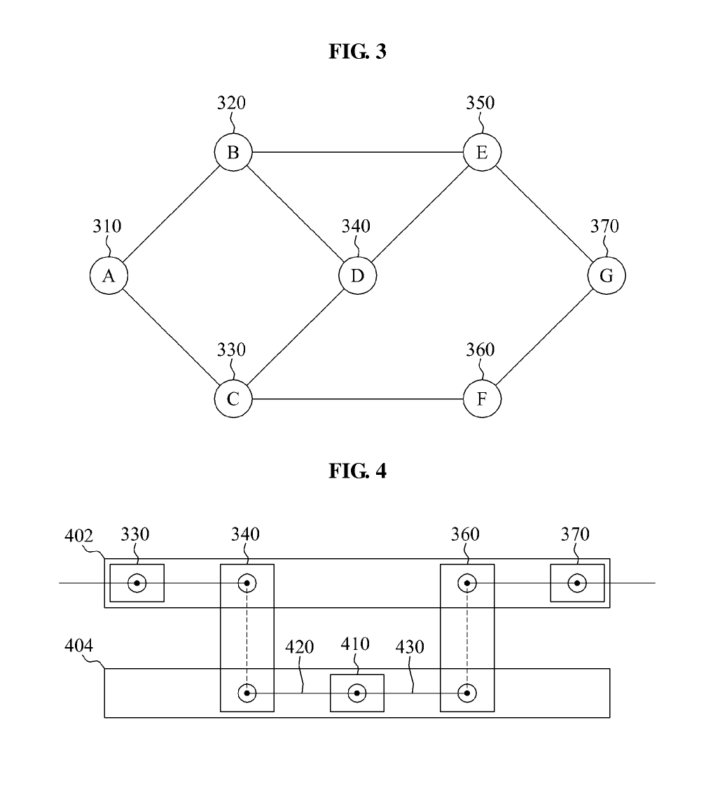

The upper layer and the lower layer of the OTN will be further described with reference to FIGS. 3 through 5.

Referring to FIG. 1, the node 100 may include a communicator 110, a processor 120, and a storage 130.

The communicator 110, the processor 120, and the storage 130 will be described with reference to FIGS. 2 through 13.

FIG. 2 is a flowchart illustrating a method of creating a virtual TE link according to an embodiment.

A first node of FIG. 2 may refer to a single instance of the node 100 of FIG. 1.

A communicator, a processor, and a storage of the first node of FIG. 2 may correspond to the communicator 110, the processor 120, and the storage 130 of the node 100, respectively.

Operations 210 through 230 may be performed by the first node.

In operation 210, the processor of the first node may determine to create a virtual TE link that connects the first node and a second node in an upper layer of an OTN. For example, the processor of the first node may determine to create the virtual TE link according to a local policy.

The second node may refer to a node that is not connected to a normal TE link of the first node in the upper layer.

In operation 220, the processor of the first node may set up an FA-LSP between the first node and the second node on a control plane of an OTN layer to create the virtual TE link. The FA-LSP may be set up through signaling between the first node and the second node. For example, the FA-LSP may be an LSP of a lower layer in which the first node is an ingress node and the second node is an egress node.

Signaling may be a resource reservation protocol (RSVP).

In the case of setting the virtual TE link in the first node to set up an LSP of the upper layer, network resources may be effectively used. However, setting of the virtual TE link may modify a network topology, which may lead to weakening a network rigidity.

According to an embodiment, as a method of decreasing a change frequency of a network topology, an FA-LSP between two nodes may be set up only on a control plane between the control plane and a data plane of a lower layer. That is, resources of the two nodes may not be allocated on the data plane with respect to the FA-LSP between the two nodes of the lower layer. For example, a bandwidth about the FA-LSP may not be allocated between the two nodes.

Resources of the lower layer of the first node are set only on the control plane and thus, resources of the lower layer may be used for a path for another traffic transfer before the setup FA-LSP is set as a TE link of the first node for the LSP of the upper layer.

The processor of the first node may set up the FA-LSP using a traffic parameter.

Actual resources for the FA-LSP on the data plane may be allocated in response to the first node receiving a request for reserving a setting of the TE link for the LSP.

A method of setting up an FA-LSP will be described with reference to FIGS. 3 through 5.

In operation 230, the processor of the first node may create the virtual TE link by registering the setup FA-LSP as a TE link of the upper layer of the first node.

The virtual TE link registered as the TE link may be employed as resources of the first node when setting up the LSP for transferring a packet.

In response to a change in the TE link of the first node in the upper layer of the OTN, the processor of the first node may update information of the TE link. That is, the processor of the first node may update information on at least one TE link. When the processor of the first node updates information on the at least one TE link, operations 210 through 230 may be performed.

Technical description made above with reference to FIG. 1 may be applicable as is and thus, further detailed description will be omitted here.

FIG. 3 illustrates an example of an upper layer of an OTN according to an embodiment.

Each of a node A 310, a node B 320, a node C 330, a node D 340, a node E 350, a node F 360, and a node G 370 may correspond to the node 100 of FIG. 1.

That is, each of the node A 310, the node B 320, the node C 330, the node D 340, the node E 350, the node F 360, and the node G 370 may refer to a single instance of the node 100, and may express that the node 100 performs a different function.

A communicator of each of the node A 310, the node B 320, the node C 330, the node D 340, the node E 350, the node F 360, and the node G 370 may correspond to the communicator 110 of the node 100.

A layer in which the node A 310, the node B 320, the node C 330, the node D 340, the node E 350, the node F 360, and the node G 370 are present may be an upper layer of an OTN. A link connected between nodes, for example, the node A 310, the node B 320, the node C 330, the node D 340, the node E 350, the node F 360, and the node G 370 may be a TE link of each node.

For example, at least one TE link of the node 310 may include a link between the node A 310 and the node B 320 and a link between the node A 310 and the node C 330.

The node A 310 may be an ingress node. The ingress node may refer to a start node of a network over which a packet is to be transmitted.

The node G 370 may be an egress node. The egress node may refer to a last node of the network over which the packet is to be transmitted. For example, a node followed by the node G 370 may be included in a network different from the network including the node B 320, the node C 330, the node D 340, the node E 350, and the node F 360.

Each of the node B 320, the node C 330, the node D 340, the node E 350, and the node F 360 may be an intermediate node of the network.

According to an embodiment, a path from the node A 310 to the node G 370 may need to be set up to transfer a packet. Here, the path may be an LSP. To set up the LSP, the node A 310 corresponding to an ingress node may determine a subsequent node based on at least one TE link of the node A 310. For example, the subsequent node may be the node C 330. The node C 330 may determine a subsequent node based on at least one TE link of the node C 330. When a path from the node A 310 to the node G 370 is formed in the above manner, the formed path may be set up as the LSP. A packet may be transferred through the LSP. A method for setting up the LSP may be a signaling method.

When an available TE link is absent in each node, it may be impossible to set up the LSP.

Each TE link of FIG. 3 may be a normal TE link. Before signaling for the LSP is performed, each of the node A 310, the node B 320, the node C 330, the node D 340, the node E 350, the node F 360, and the node G 370 may create a virtual TE link in a corresponding node based on an FA-LSP set up in a lower layer.

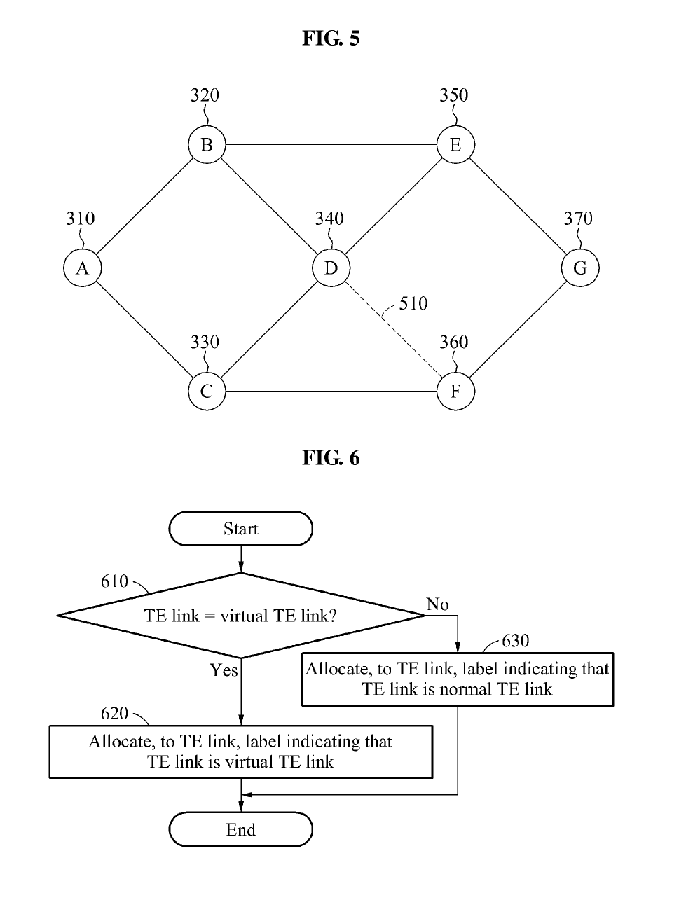

A method of creating, by a node, a virtual TE link will be further described with reference to FIGS. 4 and 5.

Technical description made above with reference to FIGS. 1 and 2 may be applicable as is and thus, further detailed description will be omitted.

FIG. 4 illustrates an example of setting up an FA-LSP in an OTN layer according to an embodiment.

The OTN layer may be a lower layer 404.

Each of the node C 330, the node D 340, the node F 360, and the node G 370 may include resources of an upper layer 402.

Also, each of the node D 340 and the node F 360 may include resources of the lower layer 404.

As described above, a normal TE link that connects the node D 340 and the node F 360 may be absent in the upper layer 402.

According to an embodiment, an LSP in which the node D 340 is an ingress node, a node H 410 is an intermediate node, and the node F 360 is an egress node may be set up in the lower layer 404.

The node H 410 may include resources of the lower layer 404.

The LSP of the lower layer 404 may be set up based on a first link 420 between the node D 340 and the node H 410 and a second link 430 between the node D 410 and the node F 360.

The first link 420 and the second link 430 may be set only on a control plane of the lower layer 404.

The LSP of the lower layer 404 set up only on the control plane of the lower layer 404 may be an FA-LSP of the upper layer 402.

Technical description made above with reference to FIGS. 1 through 3 may be applicable as is and thus, further detailed description will be omitted.

FIG. 5 illustrates an example of an upper layer in which a virtual TE link is created according to an embodiment.

A processor of the node D 340 may create a virtual TE link 510 by registering the setup FA-LSP as the TE link of the upper layer of the node D 340.

When the virtual TE link 510 is available, the processor of the node D 340 may use the virtual TE link to set up an LSP of the upper layer.

A method of setting up the LSP using the virtual TE link 510 will be further described with reference to FIG. 14.

Technical description made above with reference to FIGS. 1 through 4 may be applicable as is and thus, further detailed description will be omitted.

FIG. 6 is a flowchart illustrating a method of allocating a label to a TE link according to an embodiment.

According to an embodiment, operations 610 through 630 of FIG. 6 may be performed after operation 230 of FIG. 2.

According to another embodiment, operations 610 through 630 may be performed although operations 210 through 230 are not performed.

Operations 610 through 630 may be performed by a first node.

In operation 610, a processor of the first node may determine whether each of at least one TE link of the first node is a virtual TE link.

The processor of the first node may determine whether a TE link is a virtual TE link by referring to at least one of an LSP property value and an LSP attribute value.

When the TE link is determined as the virtual TE link, operation 620 may be performed.

Conversely, when the TE link is not determined as the virtual TE link, operation 630 may be performed.

In operation 620, the processor of the first node may allocate, to the TE link, a label indicating that the TE link is the virtual TE link.

The label indicating that the TE link is the virtual TE link may be used to allocate resources of the first node of the OTN layer for the virtual TE link when the virtual TE link is set for an LSP.

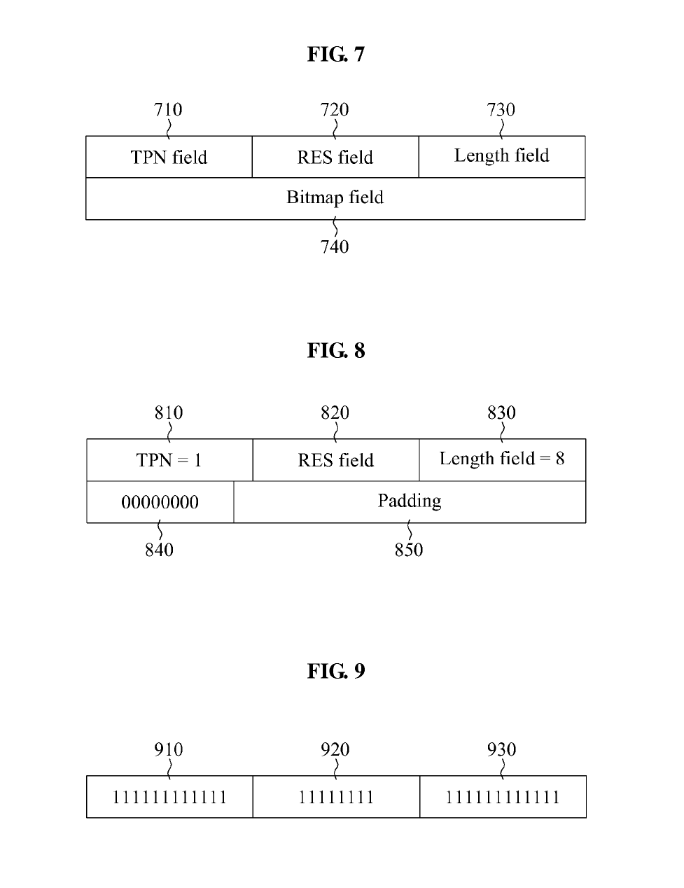

A label indicating that a TE link is a normal TE link will be further described with reference to FIGS. 7 through 12.

In operation 630, the processor of the first node may allocate, to the TE link, the label indicating that the TE link is the normal TE link.

The label indicating that the TE link is the normal TE link may be an OTN label. The OTN label will be further described with reference to FIG. 7.

Technical description made above with reference to FIGS. 1 through 5 may be applicable as is and thus, further detailed description will be omitted.

FIG. 7 illustrates an example of a format of an OTN label according to an embodiment.

A label allocated to a normal TE link may be provided in the format of the OTN label.

The OTN label may refer to a label used when using an FA-LSP of a lower layer as a TE link of an upper layer. The format of the OTN label may be specified by a standard about an OTN.

Referring to FIG. 7, the label may include a tributary port number (TPN) field 710, a reserved (RES) field 720, a length field 730, and a bitmap field 740. For example, the TPN field 710 may include 12 bits, the RES field 720 may include 8 bits, and the length field 730 may include 12 bits.

When a signal is multiplexed, a value of the TPN field 710 may be determined based on a high order and a multiplexed low order of the signal. The signal may be expressed as an optical channel data unit (ODU). The signal may include at least one of a reservation message and a packet including a payload. For example, when the signal is expressed as the ODU, a high order may be ODU2. When the high order is ODU2, the low order may be ODU1, ODUflex, or ODU1.

The value of the TPN field 710 may be determined based on the multiplexed low order. For example, when the low order is ODU0, the TPN field 710 may have a value corresponding to one of “1” through “8”.

A value of the length field 730 may be the number of tributary slots (TSs) indicated by the high order. For example, when the high order is ODU2, ODU2 may include eight tributary slots. Accordingly, the value of the length field 730 may be expressed as “8”.

The length field 730 may indicate the number of valid bits of the bitmap field 740.

The bitmap field 740 may include a bit of a variable length. The bitmap field 740 may include at least one bit corresponding to the number of tributary slots indicated by the high order.

For example, when the high order is ODU2, the bitmap field 740 may include eight bits. Each bit of the bitmap field 740 may indicate a single tributary slot. A bit indicating an allocated tributary slot may have a value of “1”.

The bitmap field 740 may indicate, using a bitmap, whether each TS of the first node for an FA-LSP is allocated. For example, when a third tributary slot among eight tributary slots is allocated for a resource, a bitmap of the bitmap field 740 may be “00100000”.

When the bitmap field 740 includes eight bits, the number of valid bits may be eight bits. Remaining bits excluding a valid bit may be padded. For example, each of remaining bits excluding a valid bit may be padded to “0”.

When a signal is mapped, the TPN field 710, the RES field 720, the length field 730, and the bitmap field 740 may have a value of “0”. That is, the label may have a value of “0”. Accordingly, it may be impossible to use “0” as a value of the label for the virtual TE link.

The label for the virtual TE link will be further described with reference to FIGS. 8 through 12.

Technical description made above with reference to FIGS. 1 through 6 may be applicable as is and thus, further detailed description will be omitted.

FIG. 8 illustrates an example of a label indicating that a TE link is a virtual TE link using a TPN field and a bitmap field according to an embodiment.

Referring to FIG. 8, the label indicating that the TE link is the virtual TE link may include a TPN field 810, a RES field 820, a length field 830, and bitmap fields 840 and 850.

The TPN field 810, the RES field 820, the length field 830, and the bitmap fields 840 and 850 may correspond to the TPN field 710, the RES field 720, the length field 730, and the bitmap field 740 of FIG. 7, respectively. Accordingly, description related to the TPN field 710, the RES field 720, the length field 730, and the bitmap field 740 may be applicable to the TPN field 810, the RES field 820, the length field 830, and the bitmap fields 840 and 850. The label indicating that the TE link is the virtual TE link may be provided in a format of an OTN label.

For example, when a high order is ODU2 and the TPN field 810 has a value of “1”, the length field 830 may have a value of “8”. Accordingly, the bitmap field 840 may include eight bits.

When the bitmap field 840 includes eight bits, each of the bits of the bitmap field 840 may have a value of “0” to indicate that the TE link is the virtual TE link. The bitmap field 850 may be padded.

In detail, when the TE link is the virtual TE link, each of at least one bit of the bitmap field 840 of the label allocated to the TE link may have a value of “0”.

Technical description made above with reference to FIGS. 1 through 7 may be applicable as is and thus, further detailed description will be omitted.

FIG. 9 illustrates an example of a label indicating that a TE link is a virtual TE link using a TPN field, a RES field, and a length field according to an embodiment.

Referring to FIG. 9, the label indicating that the TE link is the virtual TE link may include a TPN field 910, a RES field 920, and a length field 930.

The TPN field 910, the RES field 920, and the length field 930 may correspond to the TPN field 710, the RES field 720, and the length field 730 of FIG. 7, respectively. Accordingly, description related to the TPN field 710, the RES field 720, and the length field 730 may be applicable to the TPN field 910, the RES field 920, and the length field 930. The label indicating that the TE link is the virtual TE link may be provided in a format of an OTN label.

According to an embodiment, when the TE link is determined as the virtual TE link, each of bits of the TPN field 910, the RES field 920, and the length field 930 of the label allocated to the TE link may have a value of “1”.

Technical description made above with reference to FIGS. 1 through 7 may be applicable as is and thus, further detailed description will be omitted.

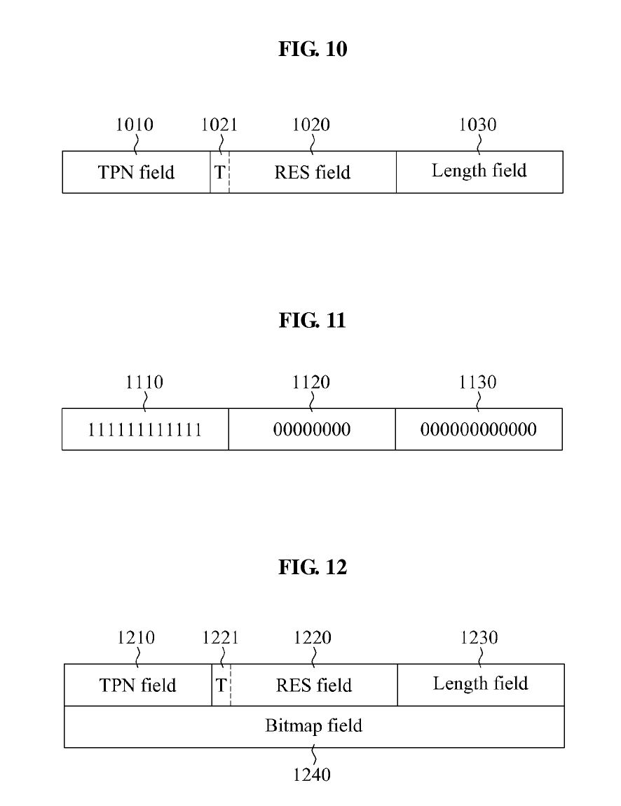

FIG. 10 illustrates an example of a label indicating that a TE link is a virtual TE link using a T-flag according to an embodiment.

Referring to FIG. 10, the label indicating that the TE link is the virtual TE link may include a TPN field 1010, a RES field 1020, and a length field 1030.

The TPN field 1010, the RES field 1020, and the length field 1030 may correspond to the TPN field 710, the RES field 720, and the length field 730 of FIG. 7, respectively. Accordingly, description related to the TPN field 710, the RES field 720, and the length field 730 may be applicable to the TPN field 1010, the RES field 1020, and the length field 1030. The label indicating that the TE link is the virtual TE link may be provided in a format of an OTN label.

The RES field 1020 may include a T-flag 1021. The T-flag 1021 may include at least one bit.

When the TE link is determined as the virtual TE link, a value of a bit indicating that the TE link is the virtual TE link may be indicated in the T-flag 1021. For example, the value of the bit indicating that the TE link is the virtual TE link may be “1”.

According to an embodiment, each of remaining bits excluding the T-flag 1021 from among bits of the RES 1020, bits of the TPN field 1010, and bits of the length field 1030 may have a value of “0”.

Technical description made above with reference to FIGS. 1 through 7 may be applicable as is and thus, further detailed description will be omitted.

FIG. 11 illustrates an example of a label indicating that a TE link is a virtual TE link using a TPN field according to an embodiment.

Referring to FIG. 11, the label indicating that the TE link is the virtual TE link may include a TPN field 1110, a RES field 1120, and a length field 1130.

The TPN field 1110, the RES field 1120, and the length field 1130 may correspond to the TPN field 710, the RES field 720, and the length field 730 of FIG. 7, respectively. Accordingly, description related to the TPN field 710, the RES field 720, and the length field 730 may be applicable to the TPN field 1110, the RES field 1120, and the length field 1130. The label indicating that the TE link is the virtual TE link may be provided in a format of an OTN label.

According to an embodiment, when the TE link is determined as the virtual TE link, each of bits of the TPN field 1110 may have a value of “1”. Each of bits of the RES field 1120 and bits of the length field 1130 may have a value of “0”.

Technical description made above with reference to FIGS. 1 through 7 may be applicable as is and thus, further detailed description will be omitted.

FIG. 12 illustrates an example of a label indicating that a TE link is a virtual TE link using a T-flag within a RES field according to an embodiment.

Referring to FIG. 12, the label indicating that the TE link is the virtual TE link may include a TPN field 1210, a RES field 1220, a length field 1230, and a bitmap field 1240.

The TPN field 1210, the RES field 1220, the length field 1230, and the bitmap field 1240 may correspond to the TPN field 710, the RES field 720, the length field 730, and the bitmap field 740 of FIG. 7, respectively. Accordingly, description related to the TPN field 710, the RES field 720, the length field 730, and the bitmap field 740 may be applicable to the RES field 1220, the length field 1230, and the bitmap field 1240. The label indicating that the TE link is the virtual TE link may be provided in a format of an OTN label.

The RES field 1220 may include a T-flag 1221. The T-flat 1221 may include at least one bit.

When the TE link is determined as the virtual TE link, a value of a bit indicating that the TE link is the virtual TE link may be indicated in the T-flag 1221. For example, the bit indicating that the TE link is the virtual TE link may have a value of “1”.

Technical description made above with reference to FIGS. 1 through 7 may be applicable as is and thus, further detailed description will be omitted.

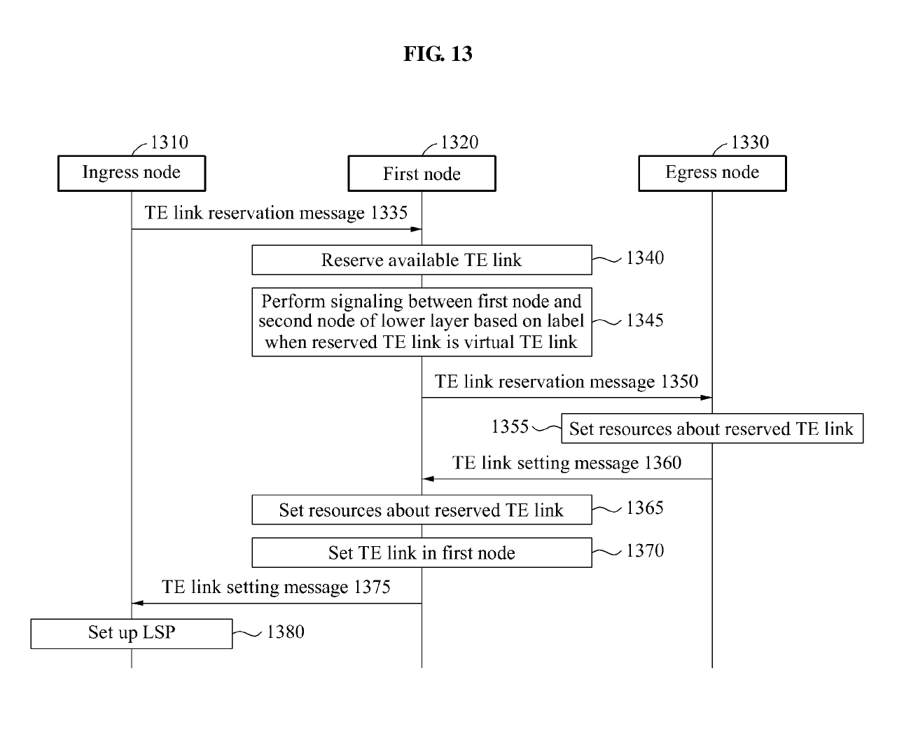

An LSP for transferring a packet may be set up in an upper layer of an OTN based on the label described above with reference to FIGS. 7 through 12. A signaling method between nodes to set up an LSP will be described with reference to FIG. 13.

FIG. 13 is a flowchart illustrating a signaling method between nodes to set up an LSP in an upper layer of an OTN according to an embodiment.

Operations 1335 through 1380 may be performed after operations 610 through 630 of FIG. 6. Operations 1335 through 1380 may be performed to set up an LSP for transferring a packet in an upper layer of an OTN.

Each of an ingress node 1310, a first node 1320, and an egress node 1330 of FIG. 13 may correspond to the node 100 of FIG. 1. That is, each of the ingress node 1310, the first node 1320, and the egress node 1330 may be a single instance of the node 100 and may express that the node 100 performs a different function.

For example, each of a communicator of the ingress node 1310, a communicator of the first node 1320, and a communicator of the egress node 1330 may correspond to the communicator 110 of the node 100.

According to an embodiment, signaling between nodes on an LSP to be set up may be performed through operations 1335 through 1380. For example, signaling may be an RSVP or a modified RSVP.

In operation 1335, the communicator of the ingress node 1310 may transmit, to the communicator of the first node 1320, a reservation message requesting a reservation of the TE link of the first node 1320 to set up the LSP.

According to an embodiment, the communicator of the first node 1320 may receive the reservation message from the ingress node 1310.

According to another embodiment, the communicator of the first node 1320 may receive, from a third node, a reservation message requesting a reservation of the TE link of the first node 1320 to set up an LSP for transferring a packet in an upper layer. The third node may be a node excluding the ingress node 1310. For example, the third node may be an intermediate node.

In operation 1340, a processor of the first node 1320 may reserve an available TE link among at least one TE link of the first node.

In operation 1345, the processor of the first node 1320 may perform signaling between the first node 1320 and a second node of a lower layer based on a label allocated to the TE link, when the reserved TE link is a virtual TE link.

The processor of the first node 1320 may perform signaling using a traffic parameter of operation 220 of FIG. 2.

Resources of the first node 1320 of the lower layer may be set through signaling.

In operation 1350, the communicator of the first node 1320 may transmit, to the second node, a reservation message requesting a reservation of a TE link of the second node for setting up the LSP.

According to an embodiment, the second node may be an intermediate node. When the second node is the intermediate node, operations 1340 through 1350 may be performed again by the second node.

According to another embodiment, the second node may be the egress node 1330.

The communicator of the egress node 1330 may receive, from the communicator of the first node 1320, a reservation message requesting a reservation of a TE link of the egress node 1330.

In operation 1355, a processor of the egress node 1330 may set resources of the egress node 1330 about the reserved TE link in the first node 1320 based on the reservation message. For example, the resources may be a tributary slot of the egress node 1330.

In operation 1360, the communicator of the egress node 1330 may transmit a setting message about setting the TE link to the communicator of the first node 1320.

According to an embodiment, the communicator of the first node 1320 may receive the setting message about setting the TE link from the communicator of the egress node 1330.

According to another embodiment, the communicator of the first node 1320 may receive the setting message about setting the TE link from the communicator of the second node.

In operation 1365, the processor of the first node 1320 may set resources of the first node 1320 about the reserved TE link in the first node 1320. For example, the resources may be a tributary slot of the first node 1320.

In operation 1370, the processor of the first node 1320 may set the reserved TE link in the first node 1320 based on the set resources.

In operation 1375, the communicator of the first node 1320 may transmit a setting message associated with setting the TE link to the third node.

For example, the third node may be the ingress node 1310.

In operation 1380, a processor of the ingress node 1310 may set up the LSP based on TE links set in nodes of the LSP to be set up.

The ingress node 1310 may transmit a packet to the egress node 1330 using the setup LSP.

Technical description made above with reference to FIGS. 1 through 12 may be applicable as is and thus, further detailed description will be omitted.

A method of setting a virtual TE link using signaling may be explained with reference to FIG. 13. Also, in addition to the method of setting a virtual TE link using signaling, a method of setting a virtual TE link may be applied to a method of setting a virtual TE link based on an operator of an OTN.

A method of setting a virtual TE link based on an operator setting may refer to a method of allocating a label value for setting up an LSP in such a manner that an operator determines an intermediate path, rather than that an intermediate node between an ingress node and an egress node searches for a path through routing.

The method of setting a virtual TE link based on an operator setting may be performed after operations 610 through 630 of FIG. 6.

The communicator of the first node 1320 may receive, from the operator of the OTN, an LSP for transferring a packet in an upper layer.

The first node 1320 may be one of nodes of the LSP.

When the TE link of the first node 1320 used for the LSP is the virtual TE link, the processor of the first node 1320 may perform signaling between the first node 1320 and the second node of the lower layer based on the label. A signal processing operation may correspond to operation 1345.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments have been shown and described, the present disclosure is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of creating a virtual traffic engineering (TE) link, performed at a first node of an optical transport network (OTN), the method comprising:
determining to create a virtual TE link that connects the first node and a second node in an upper layer of the OTN:
setting up a forwarding adjacency (FA)-label switched path (LSP) between the first node and the second node on a control plane of an OTN layer to create the virtual TE link; and
creating the virtual TE link by registering the setup FA-LSP as a TE link of the upper layer of the first node.

2. The method of claim 1, wherein the FA-LSP is set up on the control plane between the control plane and a data plane of the OTN layer.

3. The method of claim 1, wherein the setting up of the FA-LSP comprises setting up the FA-LSP using a traffic parameter.

4. The method of claim 1, further comprising:
determining whether the TE link of the first node is the virtual TE link; and
allocating a label indicating that the TE link is a normal TE link when the TE link is determined as the normal TE link.

5. The method of claim 4, further comprising:
allocating, to the TE link, a label indicating that the TE link is the virtual TE link when the TE link is determined as the virtual TE link,
wherein the label indicating that the TE link is the virtual TE link is used to allocate resources of the first node of the OTN layer for the virtual TE link when the virtual TE link is set for an LSP for transferring a packet.

6. The method of claim 5, wherein the label is provided in a format of an OTN label,
the label comprises a tributary port number (TPN) field, a reserved (RES) field, a length field, and a bitmap field, and
each of at least one bit of the bitmap field has a value of “0”.

7. The method of claim 6, wherein when a signal is multiplexed, a value of the TPN field is determined based on a high order of the signal and a multiplexed low order of the signal,
a value of the length field is the number of tributary slots indicated by the high order, and
the bitmap field comprises at least one bit corresponding to the number of tributary slots.

8. The method of claim 5, wherein the label is provided in a format of an OTN label,
the label comprises a TPN field, a RES field, and a length field, and
each of bits of the TPN field, the RES field, and the length field has a value of “1”.

9. The method of claim 5, wherein the label is provided in a format of an OTN label,
the label comprises a TPN field, a RES field, and a length field,
the RES field comprises a T-flag, and
a value indicating that the TE link is the virtual TE link is indicated in the T-flag.

10. The method of claim 9, wherein the value indicting that the TE link is the virtual TE link is “1”, and each of remaining bits excluding the T-flag from among bits of the RES field, bits of the TPN field, and bits of the length field has a value of “0”.

11. The method of claim 5, wherein the label is provided in a format of an OTN label,
the label comprises a TPN field, a RES field, and a length field,
each of bits of the TPN field has a value of “1”, and
each of bits of the RES field and bits of the length field has a value of “0”.

12. The method of claim 5, wherein the label is provided in a format of an OTN label,
the label comprises a TPN field, a RES field, a length field, and a bitmap field,
when a signal is multiplexed, a value of the TPN field is determined based on a high order of the signal and a multiplexed low order of the signal,
the bitmap field indicates, using a bitmap, whether a tributary slot of the first node for the virtual TE link is allocated, with respect to each tributary slot of the first node,
the length field indicates the number of valid bits of the bitmap field,
the RES field comprises a T-flag, and
a value of a bit indicating that the TE link is the virtual TE link is indicated in the T-flag.

13. The method of claim 1, further comprising:
receiving, from a third node, a reservation message requesting a reservation of the TE link of the first node, to set up an LSP for transferring a packet in the upper layer; and
reserving an available TE link among at least one TE link of the first node.

14. The method of claim 13, further comprising:
determining whether the TE link of the first node is the virtual TE link;
allocating, to the TE link, a label indicating that the TE link is the virtual TE link when the TE link is determined as the virtual TE link; and
performing signaling between the first node and the second node of the OTN layer based on the label, when the reserved TE link is the virtual TE link,
wherein the label is used to allocate resources of the first node of the OTN layer for the virtual TE link when the virtual TE link is set for the LSP, and
the resources of the first node are set through signaling.

15. The method of claim 14, wherein the setting up of the FA-LSP comprises setting up the FA-LSP using a traffic parameter, and
the performing of the signaling comprises performing the signaling using the traffic parameter.

16. The method of claim 13, further comprising:
transmitting, to the second node, a reservation message requesting a reservation of a TE link of the second node to set up the LSP;
receiving, from the second node, a setting message associated with setting the TE link of the second node;
setting the reserved available TE link in the first node for the LSP; and
transmitting, to the third node, the setting message associated with setting the TE link of the second node.

17. The method of claim 1, further comprising:
determining whether the TE link of the first node is the virtual TE link;
allocating, to the TE link, a label indicating that the TE link is the virtual TE link when the TE link is determined as the virtual TE link;
receiving, from an operator of the OTN, an LSP for transferring a packet in the upper layer, wherein the first node is one of nodes of the LSP; and
performing signaling between the first node and the second node of the OTN layer based on the label, when the TE link of the first node used for the LSP is the virtual TE link,
wherein the label is used to allocate resources of the first node of the OTN layer for the virtual TE link when the virtual TE link is set for the LSP, and
the resources of the first node are set through signaling.

18. A first node of an optical transport network (OTN), the first node comprising:
a processor configured to determine to create a virtual TE link that connects the first node and a second node in an upper layer of the OTN, to set up a forwarding adjacency (FA)-label switched path (LSP) between the first node and the second node in an OTN layer to create the virtual TE link, and to create the virtual TE link by registering the setup FA-LSP as a TE link of the upper layer of the first node,
wherein the FA-LSP is set up on a control plane of the OTN layer.

19. A method of allocating a label, the method comprising:
determining whether a traffic engineering (TE) link of a node of an optical transport network (OTN) is a virtual TE link; and
allocating a label indicating that the TE link is the virtual TE link when the TE link is determined as the virtual TE link,
wherein the virtual TE link is created based on a forwarding adjacency (FA)-label switched path (LSP) of a lower layer of the node,
the FA-LSP is set up on a control plane of the lower layer, and
when the virtual TE link is set for an LSP for transferring a packet, the label is used to allocate resources of the node of the lower layer for the virtual TE link.

20. The method of claim 19, wherein the label is provided in a format of an OTN label.
